(19) United States
(12) Patent Application Publication
(10) Pub. No.: US 2017/0149125 A1
(43) Pub. Date: May 25, 2017

(54) HELIX ANTENNA DEVICE

(71) Applicant: Getac Technology Corporation, Hsinchu County (TW)

(72) Inventors: Jia-Min HUANG, Taipei (TW); Jui-Lin YANG, Taipei (TW); Yen-Ching LEE, Taipei (TW)

(21) Appl. No.: 14/945,966

(22) Filed: Nov. 19, 2015

(51) Int. Cl. H01Q 1/36; H01Q 1/48

(52) U.S. Cl. CPC H01Q 1/362; H01Q 1/48

(57) ABSTRACT

A helix antenna device includes a board, a signal output circuit on the board, a column body, a ground wire, a helix antenna, and an annular metal member. The column body includes a passage and a helix trough. A bottom surface of the column body is fastened to the board. The passage is formed along a central axis of the column body. The helix trough is around an annular side surface of the column body. The ground wire passes into the passage. The ground wire is fastened to the board and is connected to the signal output circuit. The helix antenna is around the column body. A part of the helix antenna is disposed in the helix trough. The helix antenna is fastened to the board and is electrically connected to the signal output circuit. The annular metal member is disposed on the board and surrounds the column body.

### BACKGROUND OF THE INVENTION

Field of the Invention

The present invention relates to an antenna and, more particularly, to a helix antenna device.

Description of the Prior Art

Electronic devices utilizing satellites for positioning and navigating, such as a global positioning system (GPS) electronic device, are required to be wirelessly communicated with the satellites. In order to achieve the wireless communication between the satellites and the GPS electronic device, the GPS electronic device is required to have an antenna for receiving and transmitting the GPS signals. The types of antennas are varied. In the realm of GPS applications, antennas of the GPS electronic devices can be patch antennas or helix antennas. In general, the bandwidths of patch antennas for receiving signals are relatively narrow, but the bandwidths of helix antennas are relatively wide. In light of receiving the GPS signals, helix antennas are better than patch antennas.

However, since materials of helix antennas are usually soft, shapes and structures of helix antennas are inherently easily deformed by external force. During the assembly process of the helix antennas and the electronic devices or the transportation process of the assembled electronic devices, the helix antennas are usually deformed by being pressed or impacted from external force. The structural parameters of the helix antenna such as the vertical separation or the pitch angle are changed when the structures of helix antenna are deformed. The quality of the signal reception and transmission will be influenced when the structural parameters of the helix antenna have some, even minor, changes.

In order to prevent the helix antennas from deformation by external force during the assembly process and the transportation process, operators on production lines and personnel for transportation are required to be very carefully to prevent the helix antennas from being pressed or impacted; therefore, the assembly process and the transportation process are inevitably required more time. Further, the costs of production and transportation are increased substantially.

In addition, radiation strength in certain direction has no significant difference relative to radiation strength in other directions in terms of the radiation pattern of the helix antenna. In other words, the performance regarding the signal receiving ability of the helix antenna in certain direction may be insufficient. Signal input-output circuits to which the helix antenna is connected or circuits on the electronic device may also impact the signal receiving ability of the helix antenna negatively.

To resolve the above issue, it is desperate to people in the art to find solutions such that the helix antennas can be conveniently assembled to the boards and are hard to be deformed by external force so as to avoid influence of the structural parameters of the helix antennas, the signal receiving ability of the helix antennas can be improved, and interference to the helix antennas from the circuits can be avoided.

### SUMMARY OF THE INVENTION

According to aforementioned description, the present invention provides a helix antenna device. It is convenient and accurate to have a helix antenna assembled to a board, and the structure of the helix antenna is hard to be deformed by external force so that the structural parameters of the helix antenna can be maintained. In addition, the signal receiving ability and the anti-interference ability of the helix antennas can be improved.

An embodiment of the present invention provides a helix antenna device comprising a board, a signal output circuit, a column body, a ground wire, a helix antenna, and an annular metal member. The signal output circuit is disposed on the board. The column body comprises a passage and a helix trough. A bottom surface of the column body is fastened to the board. The passage is along a central axis of the column body. The helix trough is formed around an annular side surface of the column body. The ground wire passes into the passage. One end of the ground wire is fastened to the board and is electrically connected to the signal output circuit. The helix antenna is around the column body. At least a part of the helix antenna is disposed in the helix trough. One end of the helix antenna is fastened to the board and is electrically connected to the signal output circuit. The annular metal member is disposed on the board and surrounds the column body.

According to an embodiment, the board comprises a circuit layer, a first insulating layer, a ground layer, and a second insulating layer. The first insulating layer is between the circuit layer and the ground layer. The ground layer is between the first insulating layer and the second insulating layer. The signal output circuit is disposed on the circuit layer.

According to an embodiment, the signal output circuit and the helix antenna are isolated from each other by the ground layer along a perpendicular direction relative to the ground layer.

According to an embodiment, a bottom segment of the helix antenna passes through the second insulating layer, the ground layer, and the first insulating layer, and is fastened to and is electrically connected to the circuit layer.

According to an embodiment, the annular metal member defines a first annular opening cross-section and a second annular opening cross-section. The first annular opening cross-section is adjacent to the board. The second annular opening cross-section is spaced from the board by a perpendicular height. The area of the first annular opening cross-section is less than that of the second annular opening cross-section. The areas of the cross-sections of the annular metal member gradually increase along a direction from the first annular opening cross-section toward the second annular opening cross-section.

According to an embodiment, a top segment of the helix antenna is away from the board. The top segment of the helix antenna has a radial cross-section defining a normal vector parallel with a tangent vector tangent to the annular side surface of the column body.

According to an embodiment, the board comprises a first hole and a second hole. A bottom segment of the ground wire passes into and is fastened to the first hole. A bottom segment of the helix antenna passes into and is fastened to the second hole.

According to an embodiment, the column body further comprises at least a fastener. The board further comprises at least a third hole. The at least a fastener protrudes from the bottom surface of the column body. The at least a fastener is capable of being coupled to the at least a third hole.

Concisely, the helix antenna of the helix antenna device of the embodiments of the present invention is disposed on the column body, and then the helix antenna is assembled to the board via the column body. The assembly process of the helix antenna is convenient and accurate. The assembled helix antenna is supported by the column body; therefore, the shape and the structure of the helix antenna are hard to be deformed so as to ensure that the structural parameters of the helix antenna can be maintained. The annular metal member can not only improve the signal receiving ability of the helix antenna along the perpendicular direction relative to the board but also isolate the interference from a parallel direction parallel with the board. The signal output circuit and the helix antenna are isolated from each other by the ground layer such that the interference from the signal output circuit can be isolated. As a result, the anti-interference ability of the helix antennas in terms of the signal reception and transmission can be improved based on the cooperation of the annular metal member and the ground layer.

The features of the present invention will no doubt become understandable to those of ordinary skill in the art after reading the following detailed description of the preferred embodiment that is illustrated in the various figures and drawings.

### BRIEF DESCRIPTION OF THE DRAWINGS

FIG. 1 illustrates a perspective view of a helix antenna device according to an embodiment of the present invention;

FIG. 2 illustrates a perspective view of the helix antenna device rotated 180 degrees from the view of FIG. 1;

FIG. 3 illustrates an exploded view of the helix antenna device of FIG. 1;

FIG. 4 illustrates a perspective view of an aspect of a helix antenna, a ground wire, and a column body of FIG. 1;

FIG. 5 illustrates a cross-sectional view taken along line 5-5 of FIG. 1;

FIG. 6 illustrates a side view of the helix antenna, the ground wire, and the column body of FIG. 4; and

FIG. 7 illustrates a cross-sectional view taken along line 7-7 of FIG. 6.

### DETAILED DESCRIPTION OF THE EMBODIMENTS

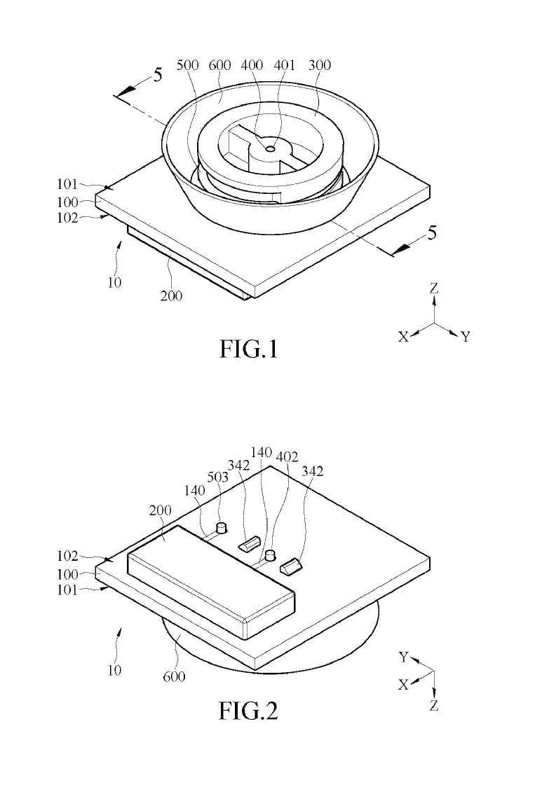

Referring to FIG. 1 and FIG. 2, FIG. 1 illustrates a perspective view of a helix antenna device 10 according to an embodiment of the present invention, and FIG. 2 illustrates a perspective view of the helix antenna device 10 rotated 180 degrees about the X-axis from the view of FIG. 1. In an embodiment, the helix antenna device 10 can be assembled to certain electronic device (e.g., a portable device or a vehicle navigation device) to receive radio frequency signals (e.g., GPS signals).

The helix antenna device 10 comprises a board 100, a signal output circuit 200, a column body 300, a ground wire 400, a helix antenna 500, and an annular metal member 600. The board 100 comprises a first surface 101 and a second surface 102. The first surface 101 and the second surface 102 are opposite to each other. The signal output circuit 200 is disposed on the second surface 102 of the board 100. The column body 300 is fastened to the board 100. The signal output circuit 200 comprises several electric components such as a filter, a low noise amplifier, and a ground circuit. The ground wire 400 and the helix antenna 500 are disposed on the column body 300. Moreover, the ground wire 400 and the helix antenna 500 are electrically connected to the signal output circuit 200. The annular metal member 600 is disposed on the board 100 and surrounds the column body 300.

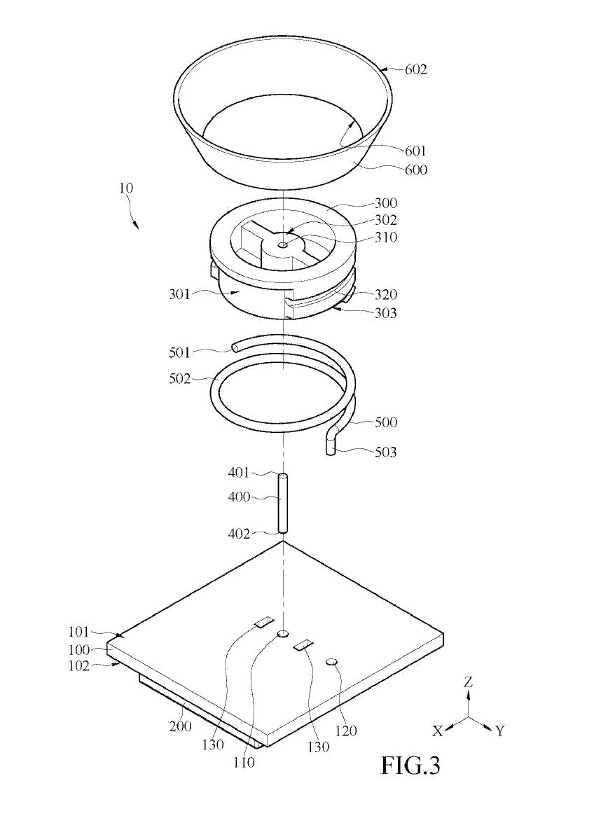

Referring to FIG. 3 and FIG. 4, FIG. 3 illustrates an exploded view of the helix antenna device 10 of FIG. 1, and FIG. 4 illustrates a perspective view of an aspect of the helix antenna 500, the ground wire 400, and the column body 300 of FIG. 1. The column body 300 comprises a passage 310 and a helix trough 320. In the embodiment, the column body 300 has a shape of circular column. An annular side surface 301 of the column body 300 is coaxial with a central axis of the column body 300 and is around the side of the column body 300. The central axis of the column body 300 is parallel with the Z-axis. A top surface 302 and a bottom surface 303 of the column body 300 are respectively at two opposite ends of the column body 300 along the central axis thereof The bottom surface 303 of the column body 300 is fastened to the board 100. The bottom surface 303 is on the first surface 101 of the board 100. The passage 310 is formed along the central axis of the column body 300. The passage 310 penetrates trough the column body 300 from the top surface 302 to the bottom surface 303. The helix trough 320 is formed around the annular side surface 301 of the column body 300.

The ground wire 400 has a line-shaped structure. The ground wire 400 has a top segment 401 and a bottom segment 402. The bottom segment 402 is at one end of the ground wire 400, and the top segment 401 is at the other end of the ground wire 400 opposite to the bottom segment 402. The ground wire 400 passes into the passage 310. The top segment 401 is inside the passage 310. The bottom segment 402 extends outside the bottom surface 303 of the column body 300 and is fastened to the board 100. The column body 300 and the ground wire 400 are perpendicular to the first surface 101 and the second surface 102 of the board 100. The first surface 101 and the second surface 102 of the board 100 are parallel with the XY-plane.

The helix antenna 500 may be a helical structure. The helix antenna 500 has a top segment 501, a body 502, and a bottom segment 503. The bottom segment 503 is at one end of the helix antenna 500, and the top segment 501 is at the other end of the helix antenna 500. The body 502 is between the top segment 501 and the bottom segment 503. The helix antenna 500 is around the column body 300 and at least a part of the helix antenna 500 is disposed in the helix trough 320. In particular, the body 502 has a helical structure and is around the annular side surface 301 of the column body 300. The top segment 501 is away from the board 100 with respect to the bottom segment 503. The bottom segment 503 is bended and extends toward the board 100 along a direction parallel with the negative Z-direction; therefore, the bottom segment 503 is parallel with the ground wire 400 and the central axis of the column body 300. The bottom segment 503 is fastened to the board 100. The top segment 501 and the body 502 are located at a side of the board 100 relative to the signal output circuit 200. In other words, the board 100 is between the top segment 501 and the body 502 of the helix antenna 500 and the signal output circuit 200.

In an embodiment, the column body 300 further comprises a plurality of flanges 330. The flanges 330 are around the annular side surface 301 of the column body 300 and are arranged in spaced relationship. The intervals between two adjacent flanges 330 along the Z-direction form the helix trough 320. The flanges 330 are used to form a part of the helix trough 320, namely that the flanges 330 are around the annular side surface 301 and form a non-continuous helical structure. As a result, there are notches 331 formed between the spaced flanges 330 along the helical structure. A part of the body 502 is disposed in the helix trough 320, and the other part of the body 502 is located at the notches 331. The flanges 330 support the helix antenna 500 well to maintain the shape and the structure of the helix antenna 500 even though the flanges 330 merely form a part of the helix trough 320.

In an embodiment, the board 100 comprises a first hole 110 and a second hole 120. The first hole 110 is corresponding to the ground wire 400. The second hole 120 is corresponding to the helix antenna 500. The bottom segment 402 at one end of the ground wire 400 is fastened to the first hole 110. The bottom segment 503 at one end of the helix antenna 500 is fastened to the second hole 120.

In an embodiment, the board 100 comprises two board circuits 140. The two board circuits 140 are disposed on the second surface 102. One of the two board circuits 140 is electrically connected between an inner wall (not shown) of the first hole 110 and the signal output circuit 200, and, analogously, the other board circuit 140 is electrically connected between an inner wall (not shown) of the second hole 120 and the signal output circuit 200. In particular, the bottom segment 402 of the ground wire 400 and the bottom segment 503 of the helix antenna 500 are respectively electrically connected to the inner walls of the first hole 110 and the second hole 120, and are electrically connected to the signal output circuit 200 via the board circuits 140. In other embodiments, the board circuits 140 can be disposed inside the board 100 or can be disposed on the first surface 101 of the board 100.

In an embodiment, the board 100 further comprises at least a third hole 130 in addition to the first hole 110 and the second hole 120. The column body 300 further comprises at least a fastener 340 protruding from the bottom surface 303 of the column body 300. For the convenience of description, an example that two third holes 130 and two fasteners 340 are provided is described below. The two fasteners 340 are symmetrical. The two third holes 130 are respectively corresponding to the two fasteners 340. The two fasteners 340 are capable of being respectively coupled to the two third holes 130. In other embodiments, the number of the fastener 340 can be one or can be greater than two, and, accordingly, the number of the third hole 130, corresponding to the fastener 340, can be one or can be greater than two. In an embodiment, the first hole 110, the second hole 120, and the third holes 130 are aligned along a direction and are arranged in spaced relationship. In other embodiments, the first hole 110, the second hole 120, and the third holes 130 are disposed separately.

In an embodiment, the fastener 340 comprises an extending portion 341 and a hook portion 342. The extending portion 341 has a shape of rectangular column. The hook portion 342 has a shape of triangular column. One end of the extending portion 341 is connected to the hook portion 342, and the other end of the extending portion 341 is connected to the bottom surface 303 of the column body 300. The two hook portions 342 of the two fasteners 340 extend away from each other. After the extending portion 341 passes into the third hole 130, the bottom surface 303 of the column body 300 is against the first surface 101 of the board 100, and the hook portion 342 is against the second surface 102 of the board 100.

One of the features of the present invention is that the helix antenna 500, the ground wire 400, and the column body 300 can be easily and accurately assembled to the board 100 by the use of the first hole 110, the second hole 120, and the third hole 130. During assembly, firstly assembly personnel can have the bottom segment 402, the bottom segment 503, and the fastener 340 respectively aligned with the first hole 110, the second hole 120, and the third hole 130, and, secondly, assembly personnel can slightly force the column body 300 and the board 100 to be close to each other along the Z-axis so as to have the bottom segment 402 passed into the first hole 110, have the bottom segment 503 passed into the second hole 120, and have the fasteners 340 passed into the third holes 130. After the two hook portions 342 completely pass through the two third holes 130, the hook portions 342 are against the second surface 102 of the board 100, and the bottom surface 303 of the column body 300 are against the first surface 101 of the board 100; therefore, the board 100 is sandwiched between the bottom surface 303 of the column body 300 and the hook portions 342. In other words, the relative position of the column body 300 and the board 100 can be maintained by the cooperation of the bottom surface 303 of the column body 300 and the hook portions 342.

As shown in FIG. 2, the bottom segment 402 and the bottom segment 503 extend slightly outside the second surface 102 of the board 100 after the hook portions 342 completely pass through the third holes 130. Next assembly personnel can respectively weld the intersection of the bottom segment 402 and the first hole 110 and the intersection of the bottom segment 503 and the second hole 120 to have the bottom segment 402 and the bottom segment 503 respectively electrically connected to the board circuits 140. After welding, not only can the ground wire 400 and the helix antenna 500 be respectively electrically connected to the signal output circuit 200, but also the connection between the ground wire 400, the helix antenna 500, the column body 300, and the board 100 can be more stable.

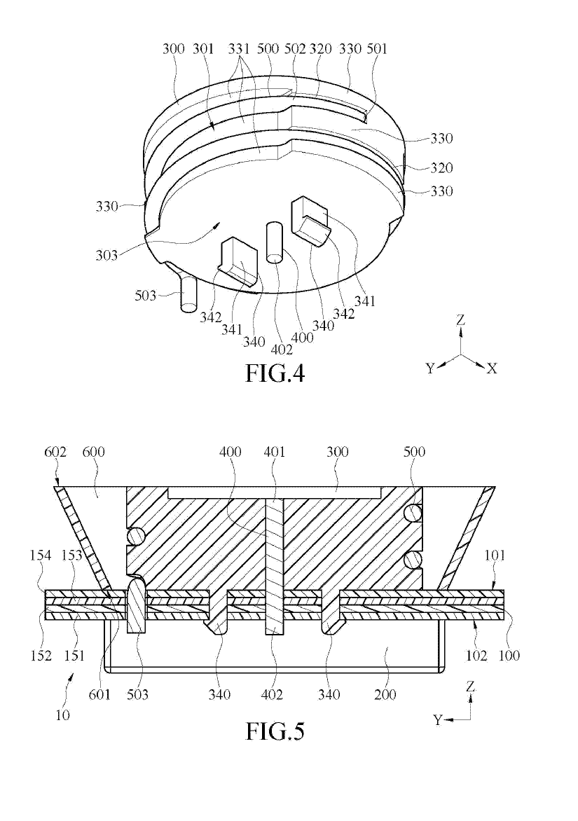

Referring to FIG. 5, FIG. 5 illustrates a cross-sectional view taken along line 5-5 of FIG. 1. In an embodiment, the board 100 is a board with multi-layers. The board 100 comprises a circuit layer 151, a first insulating layer 152, a ground layer 153, and a second insulating layer 154, wherein the circuit layer 151, the first insulating layer 152, the ground layer 153, and the second insulating layer 154 are all parallel with the XY-plane and are stacked on each other. The first insulating layer 152 is between the circuit layer 151 and the ground layer 153. The ground layer 153 is between the first insulating layer 152 and the second insulating layer 154. The signal output circuit 200 and the board circuits 140 are disposed on the circuit layer 151. In an embodiment, the bottom segment 503 of the helix antenna 500 passes through the second insulating layer 154, the ground layer 153, and the first insulating layer 152, and is fastened to and is electrically connected to the board circuit 140 of the circuit layer 151. And, analogously, the bottom segment 402 of the ground wire 400 passes through the second insulating layer 154, the ground layer 153, and the first insulating layer 152, and is fastened to and is electrically connected to the other board circuit 140 of the circuit layer 151. In other embodiments, the bottom segment 402 can pass through the second insulating layer 154 and is electrically connected to the ground layer 153. And the ground layer 153 can be connected to certain ground terminal via other circuits (not shown) inside the board 100.

The signal output circuit 200 and the helix antenna 500 are isolated from each other by the ground layer 153 along a perpendicular direction relative to the ground layer 153. The perpendicular direction is perpendicular to the ground layer 153 and is parallel with the Z-axis. In an embodiment, the top segment 501 and the body 502 of the helix antenna 500 are the main part for signal receiving. The bottom segment 503 of the helix antenna 500 is a signal feeding terminal. The bottom segment 503 is utilized for transmitting received signals to the signal output circuit 200. The signal output circuit 200 is isolated from the top segment 501 and the body 502 of the helix antenna 500 along the Z-direction. The helix antenna 500 does not interfered by the signal output circuit 200 (or other electrical components installed on the helix antenna device 10) when the helix antenna 500 receives signal. As a result, the stability of the helix antenna 500 concerning signal receiving can be secured.

The annular metal member 600 surrounds the top segment 501 and the body 502 of the helix antenna 500 along the Z-axis; therefore, the annular metal member 600 can isolate interference from any directions. The ground layer 153 can isolate interference from the Z-direction or Z-components. Based on the cooperation of the ground layer 153 and the annular metal member 600, the helix antenna 500 has a significant anti-interference ability such that the helix antenna 500 can receive signals more efficiently from certain direction, e.g., the incoming direction of the GPS signals from the positive Z-direction, as shown in FIG. 1. In different embodiments, the annular metal member 600 can be fastened to the first surface 101 of the board 100 in a manner of adhering, welding, or fastening.

In an embodiment, as shown in FIG. 3 and FIG. 5, a first annular opening cross-section and a second annular opening cross-section are defined by the annular metal member 600. The first annular opening cross-section is adjacent to the first surface 101 of the board 100. The second annular opening cross-section is away from the first surface 101 of the board 100. In the embodiment, the first annular opening cross-section is an annular bottom surface 601 of the annular metal member 600, and the second annular opening cross-section is an annular top surface 602 of the annular metal member 600.

The annular bottom surface 601 and the annular top surface 602 are parallel with the XY-plane. The annular top surface 602 is spaced from the first surface 101 of the board 100 by a perpendicular height, and the term “perpendicular” means being parallel with the Z-axis and perpendicular to XY-plane. The perpendicular height is substantially equal to the height of the column body 300 (except the fastener 340) which is relative to the first surface 101 along the Z-direction. In other words, the top segment 501 and the body 502 of the helix antenna 500 do not extend outside the annular top surface 602 along the Z-direction so as to ensure the annular metal member 600 has a better effect in terms of isolating interference.

In addition, the area of the annular bottom surface 601 is less than that of the annular top surface 602. The areas of the cross-sections of the annular metal member 600 gradually increase along the positive Z-direction from the annular bottom surface 601 toward the annular top surface 602. The term “cross-section” means the cross-section of the annular metal member 600 parallel with the XY-plane. In other words, one of the features of the present invention is that the geometric structure of the annular metal member 600 similar to a truncated cone is beneficial of improving the ability of the helix antenna 500 for receiving signals from certain direction, e.g., from the positive Z-direction shown in FIG. 1. In other embodiment, the helix antenna 500 can be utilized for two-way communication, namely that the helix antenna 500 is utilized for transmitting and receiving signals. Under the circumstance, the annular metal member 600 is not only beneficial of the ability of the helix antenna 500 for receiving signals from certain direction but is also beneficial of the ability of the helix antenna 500 for transmitting signals toward certain direction.

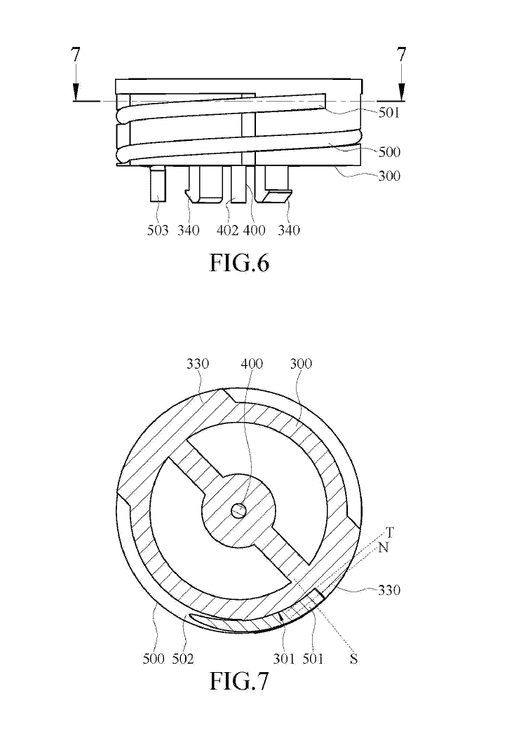

Referring to FIG. 6 and FIG. 7, FIG. 6 illustrates a side view of the helix antenna 500, the ground wire 400, and the column body 300 of FIG. 4, and FIG. 7 illustrates a cross-sectional view taken along line 7-7 of FIG. 6. In the embodiment, the top segment 501 of the helix antenna 500 has a radial cross-section defining a normal vector parallel with a tangent vector tangent to the annular side surface 301 of the column body 300. In particular, the top segment 501 has a cross-section taken along a virtual plane S, i.e., the radial cross-section of the top segment 501, and defining a normal vector N. There is a tangent vector T tangent to the annular side surface 301 of the column body 300 at an intersection of the annular side surface 301 and the virtual plane S. The normal vector N is parallel with the tangent vector T. In other words, the top segment 501 and the body 502 mutually form a helical structure. The helix antenna device 10 of the embodiment can generate a more circular radiation pattern or a more omnidirectional radiation pattern to increase the ability to receive signals of electromagnetic waves in all directions.

In the embodiment, the helix antenna device 10 is used for receiving circular polarized signals. The helix antenna 500 is used for being a signal feeding route, and the ground wire 400 is grounded. The cooperation of the helix antenna 500 and the ground wire 400 is capable of receiving signals with particular frequencies. For example, the helix antenna device 10 is capable of receiving the GPS signals based on particular structural parameters such as the vertical separation and the pitch angle of the helix antenna 500 and the radius of a turn on the helix antenna 500 between the helix antenna 500 and the ground wire 400. Moreover, the ground wire 400 is disposed inside the helix antenna 500 (i.e., the ground wire 400 is disposed alone the central axis of the helix antenna 500), and signals are fed in through the bottom segment 503 of the helix antenna 500; therefore, the magnetic flux in the helix antenna 500 can be increased such that the helix antenna device 10 is good at receiving the GPS signals in all direction.

One of the features of the present invention is that the ability of the helix antenna device 10 for receiving the GPS signals from certain direction is improved by the utilization of the annular metal member 600. For example, the annular metal member 600 surrounds the Z-axis which is the central axis of the annular metal member 600, and the inner wall of the annular metal member 600 is inclined toward the Z-axis and gradually reduces along the negative Z-direction. Therefore, the annular metal member 600 can concentrate the GPS signals transmitted from the positive Z-direction on the place where the helix antenna 500 and the ground wire 400 are via reflection. In other words, the radiation pattern of the helix antenna device 10 is mostly restricted inside the annular metal member 600, namely that the helix antenna device 10 has a better signal receiving ability inside the annular metal member 600 along the positive Z-direction relative to that outside the annular metal member 600 when the GPS signals come from the positive Z-direction.

While the present invention has been described by way of example and in terms of the preferred embodiments, it is to be understood that the present invention needs not be limited to the disclosed embodiments. For anyone skilled in the art, various modifications and improvements within the spirit of the present invention are covered under the scope of the present invention. The covered scope of the present invention is based on the appended claims.

What is claimed is:

1. A helix antenna device, comprising:
a board;
a signal output circuit disposed on the board;
a column body comprising a passage and a helix trough, a bottom surface of the column body being fastened to the board, the passage being along a central axis of the column body, the helix trough being formed around an annular side surface of the column body;
a ground wire passing into the passage, one end of the ground wire being fastened to the board and being electrically connected to the signal output circuit;
a helix antenna around the column body, at least a part of the helix antenna being disposed in the helix trough, one end of the helix antenna being fastened to the board and being electrically connected to the signal output circuit; and
an annular metal member disposed on the board and surrounding the column body.

2. The helix antenna device of claim 1, wherein the board comprises a circuit layer, a first insulating layer, a ground layer, and a second insulating layer, the first insulating layer is between the circuit layer and the ground layer, the ground layer is between the first insulating layer and the second insulating layer, and the signal output circuit is disposed on the circuit layer.

3. The helix antenna device of claim 2, wherein the signal output circuit and the helix antenna are isolated from each other by the ground layer along a perpendicular direction relative to the ground layer.

4. The helix antenna device of claim 2, wherein a bottom segment of the helix antenna passes through the second insulating layer, the ground layer, and the first insulating layer, and is fastened to and is electrically connected to the circuit layer.

5. The helix antenna device of claim 1, wherein the annular metal member defines a first annular opening cross-section and a second annular opening cross-section, the first annular opening cross-section is adjacent to the board, the second annular opening cross-section is spaced from the board by a perpendicular height, the area of the first annular opening cross-section is less than that of the second annular opening cross-section, and the areas of the cross-sections of the annular metal member gradually increase along a direction from the first annular opening cross-section toward the second annular opening cross-section.

6. The helix antenna device of claim 1, wherein a top segment of the helix antenna is away from the board, and the top segment of the helix antenna has a radial cross-section defining a normal vector parallel with a tangent vector tangent to the annular side surface of the column body.

7. The helix antenna device of claim 1, wherein the board comprises a first hole and a second hole, a bottom segment of the ground wire passes into and is fastened to the first hole, and a bottom segment of the helix antenna passes into and is fastened to the second hole.

8. The helix antenna device of claim 7, wherein the column body further comprises at least a fastener, the board further comprises at least a third hole, the at least a fastener protrudes from the bottom surface of the column body, and the at least a fastener is capable of being coupled to the at least a third hole.
